(19) United States
(12) Patent Application Publication
(10) Pub. No.: US 2003/0154482 A1
(43) Pub. Date: Aug. 14, 2003

(54) Digital broadcast receiver

(76) Inventors: Keisuke Tsukamoto, Osaka (JP); Toshihiro Takagi, Osaka (JP); Tatsuo Miyagawa, Osaka (JP); Yasuhiro Inui, Osaka (JP)

Correspondence Address: Jonathan P. Osha, ROSENTHAL & OSHA L.L.P., Suite 2800, 1221 McKinney St., Houston, TX, 77010, US

(21) Appl. No.: 10/348,551

(22) Filed: Jan. 21, 2003

(30) Foreign Application Priority Data
Jan. 21, 2002 (JP) P2002-011264

(51) Int. Cl. H04N 7/16; G06F 3/00; H04N 5/445; G06F 13/00; H04N 7/173

(52) U.S. Cl. 725/53; 725/28; 725/131; 725/139; 725/151

(57) ABSTRACT

A keyword or condition for selecting a program selection is stored in a memory in advance. When receiving a command for displaying a program select screen from a user, a broadcast receiver checks if program information acquired from a broadcast signal contains information that matches the keyword or condition. If a program, which contains information that matches the keyword or condition, is present, the program is indicated in colors, which are different from color assigned to other programs. When the program is selected by operating a cursor, information on the program is presented in the form of highlight displays. When rating information is contained in the program information of the selected program, a warning sound is generated.

The present disclosure relates to the subject matter contained in Japanese Patent Application No. 2002-011264 filed Jan. 21, 2002, which is incorporated herein by reference in its entirety.

### BACKGROUND OF THE INVENTION

1. Field of the Invention

The present invention relates to a digital broadcast receiver having a function to display an EPG (Electronic Program Guide).

2. Description of the Related Art

In a conventional digital television broadcast, EPG is multiplexed into a broadcast signal and is distributed. The EPG is displayed on a television monitor by depressing an “EPG key” contained in a remote controller of the broadcast receiver. A list of program constitution of each channel for each time zone is displayed on the EPG screen. The EPG screen contains a program select screen for causing the user to select a program, and a program contents display screen for presenting detailed program contents such as cast for each program. Usually, when the EPG key is depressed, the program select screen is first presented visually. The user designates a desired program while referring to the program select screen, and selects a channel broadcasting the program. The program contents display screen is displayed for a program selected by the user on the program select screen. The user selects a desired program while referring to the program select screen, and causes the broadcast receiver to display the program contents display screen, and knows the detailed program contents of the selected program.

A great amount of the program information is displayed on the screen of the television monitor in the form of the EPG. Therefore, it is troublesome for the user to grasp those pieces of information, and the user sometimes fails to grasp the information. To cope with the problem, there is proposed a broadcast receiver in which when the program contents display screen is displayed, the receiver searches the EPG program information to check if a predetermined key word is contained in the information. If such keyword is contained, the keyword is displayed in color different from that of other sentences to thereby enhance its discrimination (see JP-A-2000-341598).

In the technique of the JP-A-2000-341598, even if the program select screen is displayed for channel selection, the user cannot judge if the keyword is contained in the program information of the program displayed on the screen. To know as to if the keyword is contained in the program information of the program displayed on the screen, the user selects individual programs on the program select screen, and switches the program contents display screen (keyword searching screen) for each selected program to display the keyword and the like. Such an operation is troublesome and inconvenient. Even when the user selects a program in which the keyword is contained in the program information, on the program select screen, no action to call user's attention to it is carried out. Accordingly, there is a possibility that the user fails to watch a desired program.

In some program, rating information for limiting the viewing of a program prejudicial to the user is added to the program information of the program, and in this state, the program is distributed. The broadcast receiver disclosed, however, does not include warning means for giving the user a warning that the program selected by the user is limited in its viewing. Accordingly, even if the broadcast receiver receives the rating information, it cannot give the user a warning that the program is not to be viewed or cannot be viewed. In other words, the user cannot know which program is limited in viewing on the program select screen, and the using handiness of the broadcast receiver is not good.

### SUMMARY OF THE INVENTION

Accordingly, an object of the present invention is to provide a broadcast receiver in which a program that a user desires to view and whose program information contains a keyword and a program containing rating information attached thereto, is presented distinguishably from other programs on the EPG screen, whereby the user can easily select his or her desired program.

To achieve the above object, there is provided a digital broadcast receiver having an EPG screen display function, the digital broadcast receiver comprising; a receiving section for receiving an encoded digital/analog broadcast signal transmitted from a broadcasting station; a digital/analog decoder for decoding a broadcast signal received by the receiving section; a broadcast receiver body; a signal converter for converting a decoded signal derived from the digital/analog decoder into a signal that can be video displayed and outputting the converted signal to a display device connected to the broadcast receiver body; OSD display means for causing the display device to present a predetermined OSD display; an input section for inputting various commands including a program selection command, to the broadcast receiver body; storage means for storing program information contained in the decoded signal derived from the digital/analog decoder; a controller; and condition registering means for registering a keyword or condition input in advance by the input section for program selection, wherein the controller receives a command from the input section to prepare an EPG (Electronic Program Guide) which presents program information to the user on the basis of program information stored in the storage means, and causes the user to select a program, and causes the display device to display the prepared EPG with the aid of the OSD display means, and the controller comprises: check means for checking if information matching the keyword or condition registered in the condition registering means is contained in program information stored in the storage means when the check means receives a command from the input section; color changing/control means for outputting a signal to the display device so that when a program containing information matching the keyword or condition is present as the result of checking operation by the check means, the program containing information matching the keyword or condition is displayed in color different from that of another program on the EPG displayed; highlight display control means for outputting a signal to the display device so that when a program containing the matching information is selected by the input section, the selected program is highlighted on the EPG displayed; and warning means for outputting a signal to an audio output section connected to the broadcast receiver body so that the audio output section generates a warning sound when rating information for limiting the viewing of the program by the user is contained in program information of the program selected by the input section.

With such a construction, during the EPG screen is displayed, the check means checks if information matching a keyword or condition for program selection that is input by the user is contained in the program information. A program having the matching information is displayed on the screen of the display device in color different from that of another program, under control of the color changing/controlling means. When the program is selected by the user, it is highlighted on the display screen of the display device, under control of the highlight display control means to thereby call user's attention to it. When a program whose program information contains rating information is selected by the user on the EPG screen, a warning sound is generated by the audio output section under control of warning means to give the user a warning. A plurality of keywords or conditions for program selection maybe registered. In this case, color of the program displayed is changed every keyword or condition.

According to another aspect of the invention, there is provided a digital broadcast receiver having an EPG screen display function, the digital broadcast receiver comprising: a receiving section for receiving an encoded digital broadcast signal transmitted from a broadcasting station; a digital decoder for decoding a broadcast signal received by the receiving section; a broadcast receiver body; a signal converter for converting a decoded signal derived from the digital decoder into a signal that can be video displayed and outputting the converted signal to a display device connected to the broadcast receiver body; OSD display means for causing the display device to present a predetermined OSD display; an input section for inputting various commands including a program selection command, to the broadcast receiver body; storage means for storing program information contained in the decoded signal derived from the digital decoder; a controller; and condition registering means for registering a keyword or condition input in advance by the input section for program selection, wherein the controller receives a command from the input section to prepare an EPG (Electronic Program Guide) which presents program information to the user on the basis of program information stored in the storage means, and causes the user to select a program, and causes the display device to display the prepared EPG with the aid of the OSD display means, and the controller comprises: check means for checking if information matching the keyword or condition registered in the condition registering means is contained in program information stored in the storage means when the check means receives a command from the input section; and highlight display control means for outputting a signal to the display device so that when a program containing the matching information is selected by the input section, the selected program is highlighted on the EPG displayed.

With such a construction, during the EPG screen is displayed, the check means checks if information matching a keyword or condition for program selection that is input by the user is contained in the program information. When a program having the matching information is selected by the user, the program is highlighted on the display screen of the display device, under control of the highlight display control means to thereby call user's attention to it. A plurality of keywords or conditions for program selection may be registered.

Another aspect of the invention is that in the digital broadcast receivers, the controller includes warning means for outputting a signal audio to an output section connected to the broadcast receiver body so that the audio output section generates a warning sound when rating information for limiting the viewing of the program by the user is contained in program information of the program selected by the input section. With this feature, when a program whose program information contains rating information is selected by the user on the EPG screen during the displaying of the EPG screen, a warning sound is generated by the audio output section under control of warning means to give the user a warning.

### BRIEF DESCRIPTION OF THE DRAWINGS

FIG. 1 is a block diagram showing an electrical arrangement of a broadcast receiver that is an embodiment of the invention;

FIG. 2 is a diagram showing a program select EPG screen;

FIGS. 3(a) and 3(b) are diagrams each showing a screen for registering a keyword for selecting a program in the broadcast receiver;

FIG. 4(a) is a diagram showing a screen when a program matches a keyword, and FIG. 4(b) is a screen when a viewing-limited program is selected; and

FIG. 5 is a flow chart showing a process procedure executed by a control unit when a program select screen is displayed on a television monitor.

### DETAILED DESCRIPTION OF THE PREFFERED EMBODIMENTS

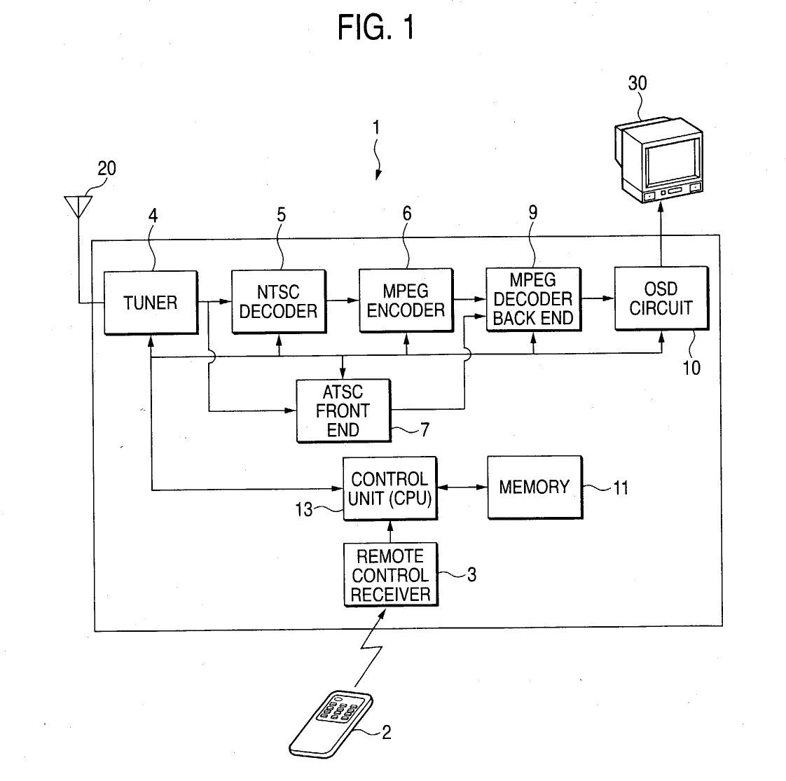

Embodiments of the present invention will be described with reference to the accompanying drawings. A block diagram showing an electrical arrangement of a digital/analog broadcast receiver that is an embodiment of the invention, is shown in FIG. 1. A digital/analog broadcast receiver (STB) 1 is connected to an antenna 20 for receiving a television broadcast signal, which is transmitted in the form of a radio wave of a predetermined frequency from a broadcasting station, and a television monitor 30 (display device, audio output section) for displaying a video image of a television broadcast. The broadcast receiver 1 receives an ATSC broadcast signal and an NTSC broadcast signal, which are transmitted from broadcasting stations, through the antenna 20, and displays video images of television programs distributed by the broadcast signals on the television monitor 30.

The broadcast receiver 1 is made up of a remote controller (input section) 2, a remote control receiver 3, a tuner (receiving section) 4, an NTSC decoder (analog decoder) 5, an MPEG encoder 6, an ATSC front end (digital decoder) 7, an MPEG decoder back end (signal converter) 9, an OSD circuit 10, a memory 11, and a control unit (controller, searching means, color changing/control means, highlight display control means, warning means) 13.

The remote controller 2 is used by the user for various operations; channel selection of a television program to be viewed, viewing reservations of television programs, displaying of the EPG screen, and others. The remote controller 2 includes various operation buttons (not shown) for those kinds of operations. When any of those buttons is operated, the remote controller wirelessly emits, a wireless signal representative of its operation, for example, an infrared rays signal.

The remote control receiver 3 receives a signal from the remote controller 2, and outputs a signal representative of an operation on the remote controller 2 to the control unit 13. The tuner 4 tunes its receiving signal frequency to a frequency corresponding to a channel selected by the remote controller 2, whereby it receives a television broadcast signal of the selected channel through the antenna 20.

When a channel of the NTSC broadcast is selected by the remote controller 2, the NTSC decoder 5 decodes the NTSC (National Television Systems Committee) broadcast signal received by the tuner 4 into video and audio signals of the television program, and outputs the video and audio signals to the MPEG encoder 6. The MPEG encoder 6 digitally compresses and encodes the video and audio signals output from the NTSC decoder 5 according to the MPEG standards, and sends the resultant to the MPEG decoder back end 9.

When a channel of the ATSC broadcast is selected by the remote controller 2, the ATSC front end 7 decodes the ATSC broadcast signal, which is received by the tuner 4 and modulated by the 8VSB method, into a TS signal in which the video and audio signals of plural television programs that are MPEG processed and the electronic program information signal are time-division multiplexed. The ATSC front end 7 separates and extracts the video and audio signals of the television program of the channel selected by the remote controller 2 from the TS signal, and outputs the separated one to the MPEG decoder back end 9, and extracts electronic program information therefrom and outputs to the control unit 13. The electronic program information contains program names, program explanation information and rating information for limiting the viewing of a program by the user.

The MPEG decoder back end 9 receives the video and audio signals output from the MPEG encoder 6 and the ATSC front end 7. Those signals are digitally compressed and encoded according to the MPEG standards. The MPEG decoder back end 9 decodes the video and audio signals so that those signals become original state in which those are not digitally compressed and encoded, thereby generating signals for displaying a video image on the television monitor 30 and outputting a sound. The video signal output from the MPEG decoder back end 9 is output to the television monitor 30 via the OSD circuit 10.

The OSD circuit 10 superimposes a channel number and given on-screen display data of EPG screen and the like to the video signal output from the MPEG decoder back end 9. As a result, an image based on the on-screen display data is displayed on the television monitor 30, while being superimposed on a video image of the television program.

The memory 11 stores frequency data of television broadcast signals of channels and various kinds of on-screen display data. The memory 11 also stores electronic program information extracted by the ATSC front end 7.

When a channel of the NTSC broadcast is selected by the remote controller 2, the control unit 13 causes the tuner 4 to receive an NTSC broadcast signal of the selected channel, and causes the NTSC decoder 5 to decode the video and audio signals. When a channel of the ATSC broadcasting is selected by the remote controller 2, the control unit causes the tuner 4 to receive an ATSC broadcast signal of the selected channel, and causes the ATSC front end 7 to separate and extract the video and audio signals of the selected channel.

The control unit 13 causes the tuner 4 to receive an ATSC broadcast signal, and stores electronic program information output from the ATSC front end 7 into the memory 11. When the remote controller 2 is operated to display the EPG screen, the control unit refers to the electronic program information stored in the memory 11, and prepares a display image of the EPG program select screen, and outputs its image signal to the OSD circuit 10. As a result, the EPG program select screen is displayed on the television monitor 30.

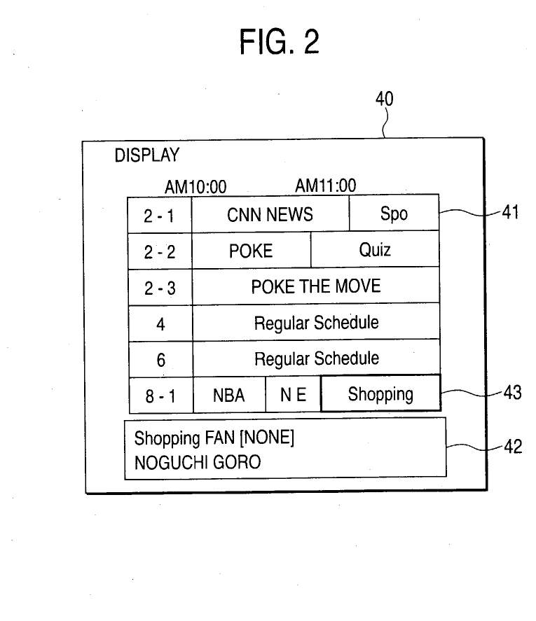

FIG. 2 is a diagram showing a program select EPG screen. A program table 41 containing a list of program constitutions of respective channels for each time zone, and a remarks column 42 for display brief explanation of a program selected by the user in the program table, are displayed on the program select screen. Each program is selected by a cursor 43 that is moved in accordance with an key operation of the remote controller. In FIG. 2, a program “Shopping” of a channel “8-1” is selected. Performers etc. of the program “Shopping” selected are displayed in the remarks column 42. Further, rating information on the viewing limitation is displayed in the remarks column 42. In this instance, “NONE” is displayed, which indicates that the viewing of the program “Shopping” is not limited.

The broadcast receiver 1 is arranged such that a keyword or condition for a program selection is input to the receiver by the user, and is stored in the memory 11. When a command for displaying a program select screen is input by the remote controller 2, the control unit 13 checks if the electronic program information stored in the memory 11 contains information which matches the keyword or condition, and presents a predetermined display on the program select screen on the basis of the check result, and calls user's attention to it. Specifically, a program in which information matching the keyword or condition is contained is displayed on the program select screen 40 by changing color of the program displayed to another color, which is different from that of other programs displayed. Here, the wording “to change color of the program displayed to another color” not only “to change hue of the program displayed against color indicating other programs displayed or the like”, but also “to change saturation or lightness of the program displayed against color indicating other programs displayed or the like”. When a program display of different color is selected by the user on the program select screen, the program and a corresponding item in the program explanation are highlighted on the screen. When rating information is contained in the program information of a program selected by the user, the control unit 13 sends a warning sound generating signal to the sound output device of the television monitor 30.

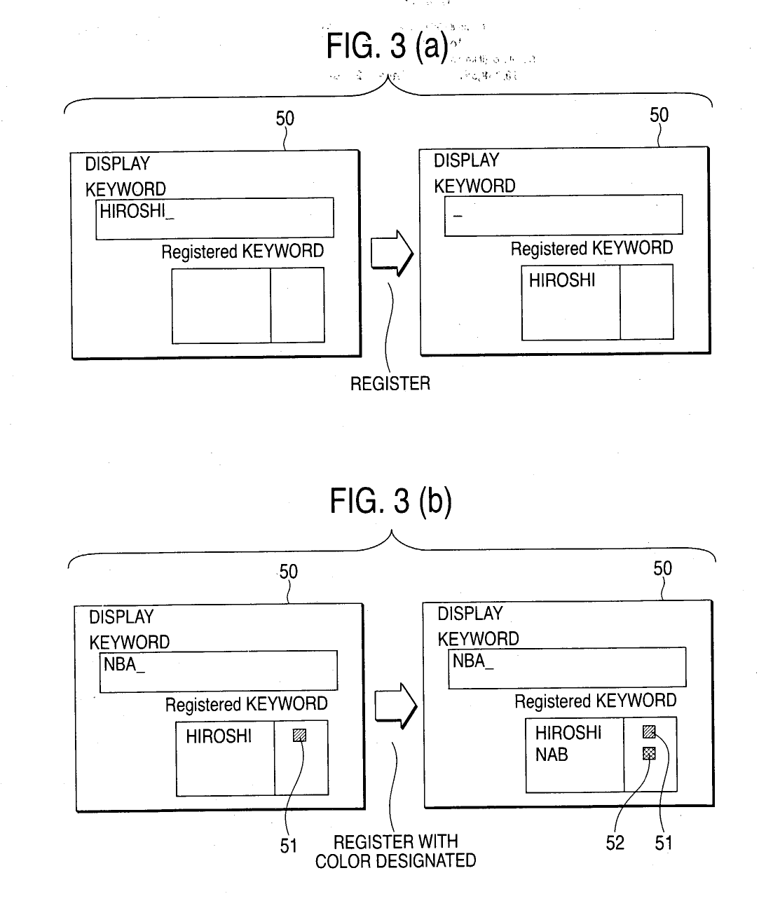

FIGS. 3(a) and 3(b) each show a keyword registering screen 50 which is presented on the television monitor 30 when a keyword for program selection is registered. The keyword registering screen 50 is displayed, for example, in a manner that a “menu” key on the remote controller 2 is depressed, a “menu screen” is displayed, and the “keyword registering screen” is selected on the menu screen. The keyword may be input in a manner that a string of characters is displayed on the screen, and the user selects desired characters from those displayed characters, or that the user enters a string of characters by use of buttons (input keys) as in the case of character string inputting by a cellular telephone. The keyword thus input, as shown in FIG. 3(a), is registered in the memory 11 when the user depresses a determination key. As shown in FIG. 3(b), a plurality of keywords maybe registered. In this case, color indicating a program may be designated for each keyword on the program select screen 40 so as to distinctively show which keyword is contained in a program displayed on the program select screen 40. In this instance, color 51 (e.g., yellow) is designated for a keyword “HIROSHI”, and color 52 (e.g., green) is designated for a keyword “NBA”. A condition for program selection may be stored in the memory 11. Rating information for activating the V-CHIP of the television monitor 30 that is distributed to the North America may be contained in the condition.

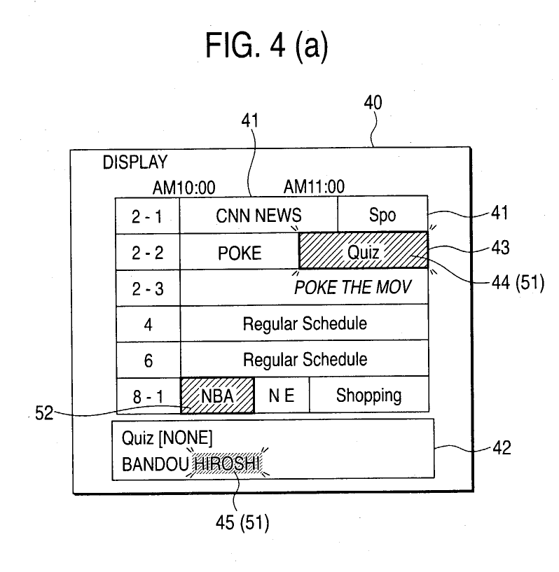

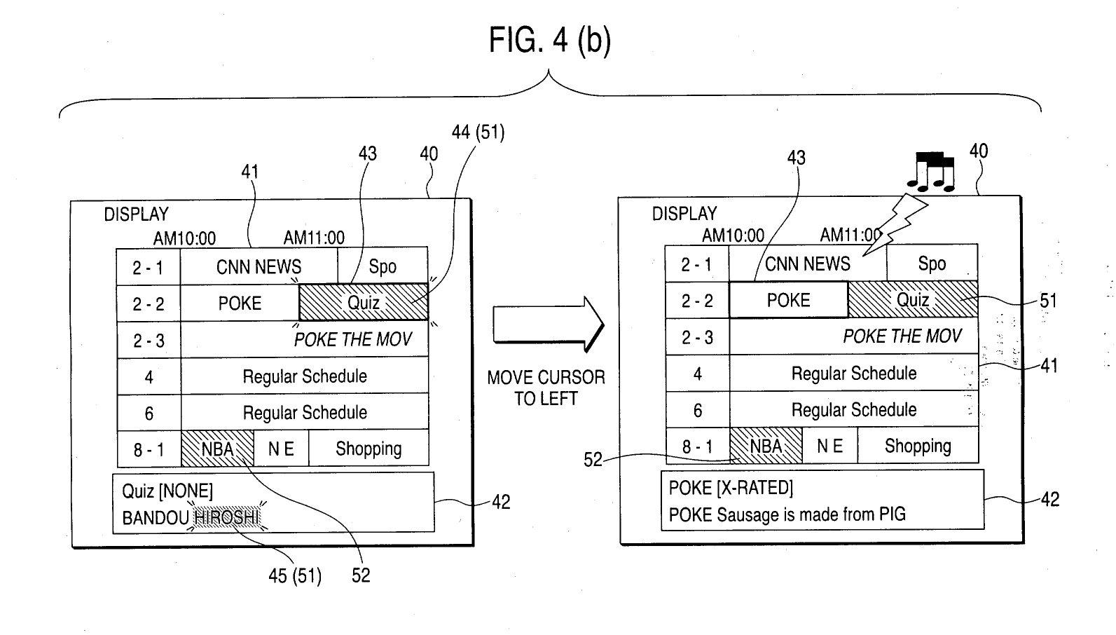

FIGS. 4(a) and 4(b) each show a program select screen 40 displayed on the television monitor 30 by the broadcast receiver 1. FIG. 4(a) shows a screen in which a program “Quiz” is selected. On the program select screen 40, the program “Quiz” whose program information contains the keyword “HIROSHI” registered in the memory 11, is displayed in the color 51 designated in FIG. 3(b). Similarly, the program “NBA” matching the keyword “NBA” is displayed in the color 52 designated in FIG. 3(b). In FIG. 4(a), the program “Quiz” is selected by use of the cursor 43, and hence, it is highlighted as indicated by reference numeral 44 in the program table 41. Further, since the keyword “HIROSHI” is contained in the program information displayed in the remarks column 42, the “HIROSHI” in the remarks column 42 is also highlighted as indicated by reference numeral 45. FIG. 4(b) shows a program select screen 40 when the cursor 43 is moved to the left on the program select screen 40 in which the program “Quiz” is selected, and a program “POKE” is selected. In this case, viewing limitation “X-RATED” is imposed on the program “POKE” selected through the movement of the cursor 43. Accordingly, a warning buzzer is driven by the sound output device of the television monitor 30 to thereby give a warning to the user.

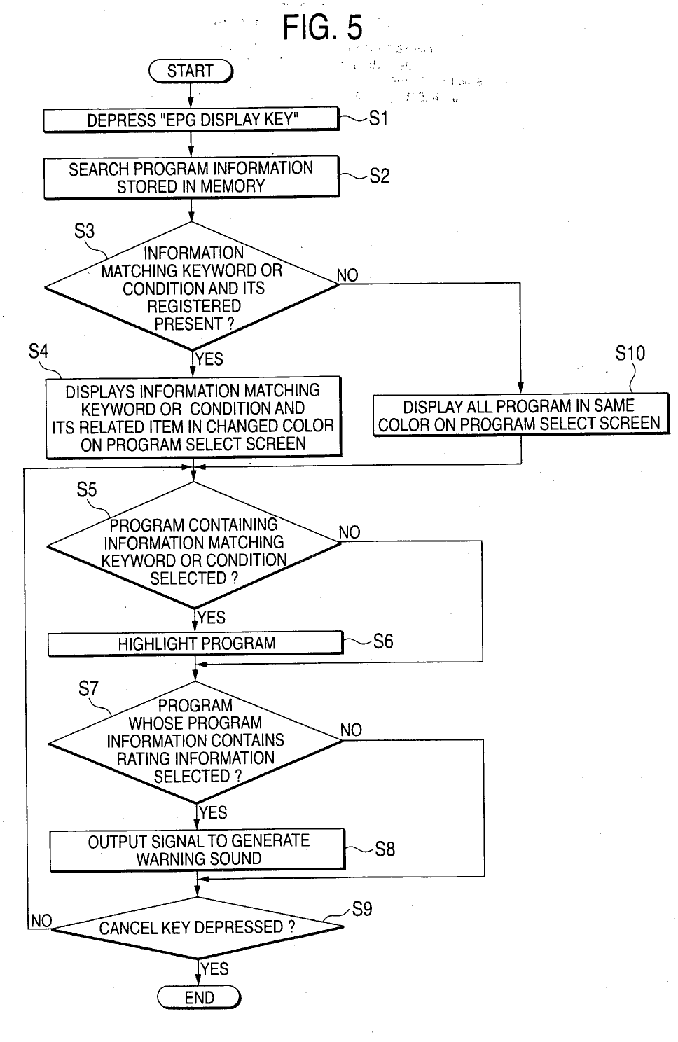

A process procedure executed by the control unit 13 when the EPG program select screen 40 is displayed on the television monitor 30, will be described with reference to FIG. 5. When an “EPG display key” on the remote controller 2 is depressed by the user (S1), the control unit searches the program information stored in the memory 11 (S2). If information matching the registered keyword or condition is present (YES in S3), the control unit displays a program containing the information matching the keyword or condition and a related item in different colors on the program select screen 40 (S4). Thereafter, if the program containing the information matching the keyword or condition is selected (YES in S5), the control unit presents a highlight display of the program (S6). If a program whose program information contains rating information (YES in S7), the control unit outputs a signal to generate a warning sound (S8). Thereafter, the user depresses a cancel key (YES in S9), and the process execution ends. When the answer is NO in the S3, the control unit displays all the programs in the same color on the program select screen 40 (S10), and advances to the S5. If the answer is No in the S5, the control unit advances to the S7, and when the answer is NO in the S7, the control unit proceeds to the S9. And if the answer is NO in the S9, the control unit proceeds to the S5.

Thus, in the broadcast receiver 1, when a program, which contains information matching the keyword or condition for program selection, is contained in the program information, it is displayed in color different from that of other programs on the EPG program select screen 40. Accordingly, the user will recognize that a program satisfying the required condition is present, without any extra operation. When such a program is selected by the user, the program is highlighted on the screen to call user's attention to it, to prevent the user from failing to watch the program. When a program whose program information contains rating information is selected on the program select screen 40, a warning sound is generated to give the user a warning. Accordingly, the user will recognize that viewing limitation is imposed to the selected program.

The present invention is not limited to the embodiment mentioned above, but may variously be modified, altered and changed within the true spirits and scope of the invention. If required, the following functions may be omitted: the function to display a program matching a keyword registered in the memory 11 in changed color on the program select screen 40; and the function to generate a warning sound when a program of which viewing is limited is selected. Also in this case, when a program whose program information contains the keyword and the like is selected by the user on the program select screen 40, information on the selected program is highlighted as indicated by numerals 44, 45 to thereby call use's attention to them. The warning sound may be generated not only when rating information is contained in the program selected by the user in the S5, but also when information to limit the viewing of the program is contained therein. A DVR (digital video recorder) maybe incorporated into the broadcast receiver 1.

As seen from the foregoing description, in a first aspect of the invention, a program which contains information matching the keyword or condition for program selection in the program information is displayed in color different from that of other programs on the EPG program select screen. Accordingly, the user can recognize that a program matching the keyword or condition is present, without any extra operation. When the program is selected by the user, the program is highlighted on the screen to thereby call user's attention to it and to thereby preventing the user from failing to watch the program. When a program whose program information contains rating information and the like is selected on the EPG screen, a warning sound is generated to give the user a warning that the program is not to be viewed or cannot be viewed. As a result, the user can recognize that viewing of the program is limited, and the broadcast receiver has favorable using handiness.

A second aspect of the invention has the following advantage: A program which contains information matching the keyword or condition for program selection in the program information is selected by the user, the program is highlighted on the screen to thereby call user's attention to it and to thereby preventing the user from failing to watch the program.

A third aspect of the invention has the following advantage: When a program whose program information contains rating information and the like is selected on the EPG screen, a warning sound is generated to give the user a warning that the program is not to be viewed or cannot be viewed. As a result, the user can recognize that viewing of the program is limited, and the broadcast receiver has favorable using handiness.

What is claimed is:

1. A digital broadcast receiver having an EPG screen display function, the digital broadcast receiver comprising:
a receiving section for receiving an encoded digital/analog broadcast signal transmitted from a broadcasting station;
a digital/analog decoder for decoding a broadcast signal received by the receiving section;
a broadcast receiver body;
a signal converter for converting a decoded signal derived from the digital/analog decoder into a signal that can be video displayed and outputting the converted signal to a display device connected to the broadcast receiver body;
OSD display means for causing the display device to present a predetermined OSD display;
an input section for inputting various commands including a program selection command, to the broadcast receiver body;
storage means for storing program information contained in the decoded signal derived from the digital/analog decoder;
a controller; and
condition registering means for registering a keyword or condition input in advance by the input section for program selection,
wherein the controller receives a command from the input section to prepare an EPG (Electronic Program Guide) which presents program information to the user on the basis of program information stored in the storage means, and causes the user to select a program, and causes the display device to display the prepared EPG with the aid of the OSD display means, and
the controller comprises:
check means for checking if information matching the keyword or condition registered in the condition registering means is contained in program information stored in the storage means when the check means receives a command from the input section;
color changing/control means for outputting a signal to the display device so that when a program containing information matching the keyword or condition is present as the result of checking operation by the check means, the program containing information matching the keyword or condition is displayed in color different from that of another program on the EPG displayed;
highlight display control means for outputting a signal to the display device so that when a program containing the matching information is selected by the input section, the selected program is highlighted on the EPG displayed; and
warning means for outputting a signal to an audio output section connected to the broadcast receiver body so that the audio output section generates a warning sound when rating information for limiting the viewing of the program by the user is contained in program information of the program selected by the input section.

2. A digital broadcast receiver having an EPG screen display function, the digital broadcast receiver comprising:
a receiving section for receiving an encoded digital broadcast signal transmitted from a broadcasting station;
a digital decoder for decoding a broadcast signal received by the receiving section;
a broadcast receiver body;
a signal converter for converting a decoded signal derived from the digital decoder into a signal that can be video displayed and outputting the converted signal to a display device connected to the broadcast receiver body;
OSD display means for causing the display device to present a predetermined OSD display;
an input section for inputting various commands including a program selection command, to the broadcast receiver body;
storage means for storing program information contained in the decoded signal derived from the digital decoder;
a controller; and
condition registering means for registering a keyword or condition input in advance by the input section for program selection,
wherein the controller receives a command from the input section to prepare an EPG (Electronic Program Guide) which presents program information to the user on the basis of program information stored in the storage means, and causes the user to select a program, and causes the display device to display the prepared EPG with the aid of the OSD display means, and
the controller comprises:
check means for checking if information matching the keyword or condition registered in the condition registering means is contained in program information stored in the storage means when the check means receives a command from the input section; and
highlight display control means for outputting a signal to the display device so that when a program containing the matching information is selected by the input section, the selected program is highlighted on the EPG displayed.

3. A digital broadcast receiver according to claim 2, wherein the controller further comprises: warning means for outputting a signal to an audio output section connected to the broadcast receiver body so that the audio output section generates a warning sound when rating information for limiting the viewing of the program by the user is contained in program information of the program selected by the input section.
